(19) United States
(12) Patent Application Publication
(10) Pub. No.: US 2007/0221028 A1
(43) Pub. Date: Sep. 27, 2007

(54) Fence assembly for cut-off machine

(75) Inventor: Jung-Huo Chen, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORPORATION LTD., TAICHUNG HSIEN (TW)

(21) Appl. No.: 11/723,767

(22) Filed: Mar. 22, 2007

(30) Foreign Application Priority Data
Mar. 23, 2006 (TW) 95204899

(51) Int. Cl. B26D 7/02

(52) U.S. Cl. 83/467.1; 83/477.1

(57) ABSTRACT

A fence assembly of a cut-off machine includes a fence base fixed above a worktable of the cut-off machine, a fence plate supported on and movable along the fence base, having a downwardly extending bottom panel and a locking structure for controlling if the fence plate is locked to the fence base. The locking structure includes a fastener defining a separation with a constant length from the fence base, a first block, a second block and a press member. The first block, the second block and the bottom panel are crowded into the constant separation. The bottom panel is disposed between the second block and the fence base. The contact surface between the first block and the second block slopes toward the direction of the separation. The first block is movable substantially perpendicularly to the direction of the separation. The press member selectively presses the first block.

### BACKGROUND OF THE INVENTION

1. Field of the Invention

The present invention relates to a cut-off machine and more specifically, to a fence assembly for a cut-off machine.

2. Description of the Related Art

Referring to FIG. 7, a conventional cut-off machine 50 includes a worktable 51, a saw arm 52, a saw blade 53 and a fence assembly 60. The worktable 51 may be made in a fixed form or rotatable form. The worktable 51 shown in FIG. 7 is a rotatable form, including a rotating table 54 and a fixed table 55. The fence assembly 60 is installed to the fixed table 55 and extends over the rotating table 54, having a lateral side perpendicular to the top surface of the rotating table 54. The saw arm 52 has one end pivoted to the rear side of the rotating table 54, and the other end holding the saw blade 53. The workpiece to be cut is placed on the worktable 51 at a suitable location. When lowering the saw arm 52, the saw blade 53 cuts the workpiece. For accurate cutting, the workpiece must be stopped against the fence assembly 60. The fence assembly 60 makes the workpiece disposed in place, as a reference for positioning. Based on the reference position at the fence assembly 60 to match with graduations 56 on the front edge of the fixed table 55 and an indicator 57 on the front side of the rotating table 54, the user can know the cutting angle of the saw blade 53 and can rotate the rotating table 54 to adjust the cutting angle.

Referring to FIG. 7 again, the fence assembly 60 is adjustable in length to fit different workpieces having different lengths and dimensions. The fence assembly 60 includes a top fence plate 61 and a bottom fence plate 62. The top fence plate 61 is above the top side of the bottom fence plate 62, and movable along the bottom fence plate 62 to adjust the length of the fence assembly 60. As shown in FIG. 8, the bottom fence plate 62 defines a sliding groove 621. The top fence plate 61 has a bottom extension 611 inserted into the sliding groove 621 of the bottom fence plate 62, and a locating groove 612 formed on the right side of the bottom extension 611. A first bolt 63 is fastened to the right side of the bottom fence plate 62 and inserted into the locating groove 612 of the top fence plate 61. A second bolt 64 is screwed through the left side of the bottom fence plate 62 and stopped against the left side of the bottom extension 611. When loosening the second bolt 64, the top fence plate 61 is unfixed and movable along the sliding groove 621 of the bottom fence plate 62. When fastening the second bolt 64, the second bolt 64 presses bottom extension 611 of the top fence plate 61 against the bottom fence plate 62. When operating the fence assembly 60, a hand of the user must move between the top fence plate 61 and the second bolt 64. According to this design, it is time-consuming to adjust the length of the fence assembly 60.

### SUMMARY OF THE INVENTION

The present invention has been accomplished to provide a fence assembly for a cut-off machine, which eliminates the drawbacks of the aforesaid conventional design.

According to an embodiment disclosed in the present invention, the fence assembly is installed in a cut-off machine and disposed on a worktable of the cut-off machine for stopping a workpiece on the worktable to be cut in position by the cut-off machine. The fence assembly includes a fence base, a fence plate, a locking structure and a press member. The fence base is fixedly provided above the worktable of the cut-off machine. The fence plate is supported on and movable along the fence base, having a downwardly extending vertical bottom panel. The locking structure for controlling if the fence plate is locked to the fence base includes a fastener defining a separation with a constant length from the fence base, a stop block, a locating block and a press member. The stop block, the locating block and the bottom panel of the fence plate are crowded into the constant separation. The bottom panel of the fence plate is disposed between the locating block and the fence base. The contact surface between the stop block and the locating block slopes toward the direction of the separation. The stop block is movable substantially perpendicularly to the direction of the separation. The press member selectively presses the stop block to prevent the movement of the stop block.

When the press member presses the stop block, the fastener provides a clamping force that holds the stop block, the locating block, the fence plate and the fence base together. The stop block is stopped from moving upwardly, and the bottom panel of the fence plate is firmly sandwiched between the locating block and the fence base, prohibiting sliding movement of the fence plate along the fence base. When operate the press member not to press the stop block and make the stop block moved upwardly, slightly, the clamping force of the fastener disappear so as to allow sliding movement of the fence plate relative to the fence base. Further, it will fasten the fence plate again by returning the press member to its former position. This design is convenience in use.

### BRIEF DESCRIPTION OF THE DRAWINGS

FIG. 1 is a perspective view showing a fence assembly installed in a cut-off machine according to an embodiment of the present invention.

FIG. 2 is an exploded view of the fence assembly according to the embodiment.

FIG. 3 is a schematic sectional view of the fence assembly according to the embodiment, showing a fence plate locked to a fence base.

FIG. 4 is a schematic rear view of the fence assembly according to the embodiment.

FIG. 5 is similar to FIG. 3, showing a press member pressed.

FIG. 6 is similar to FIG. 4, showing the fence plate unlocked and moved relative to the fence base.

FIG. 7 is a perspective view of a conventional cut-off machine.

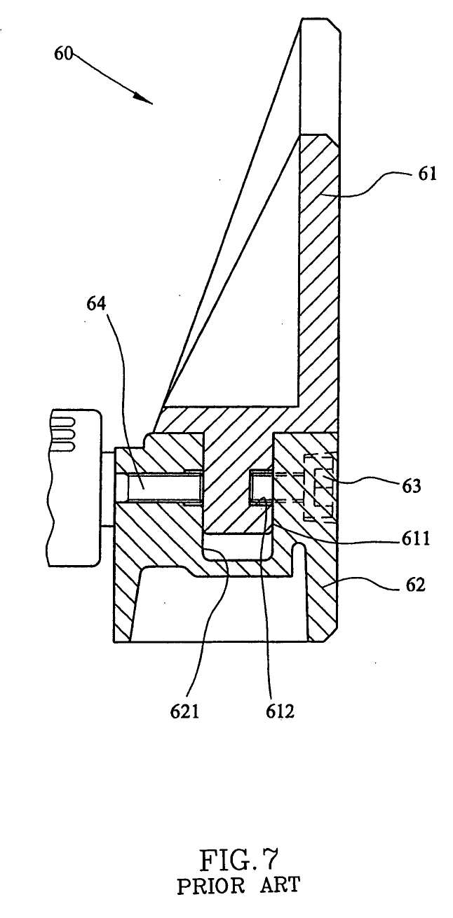

FIG. 8 is a sectional view of a fence assembly in a prior art.

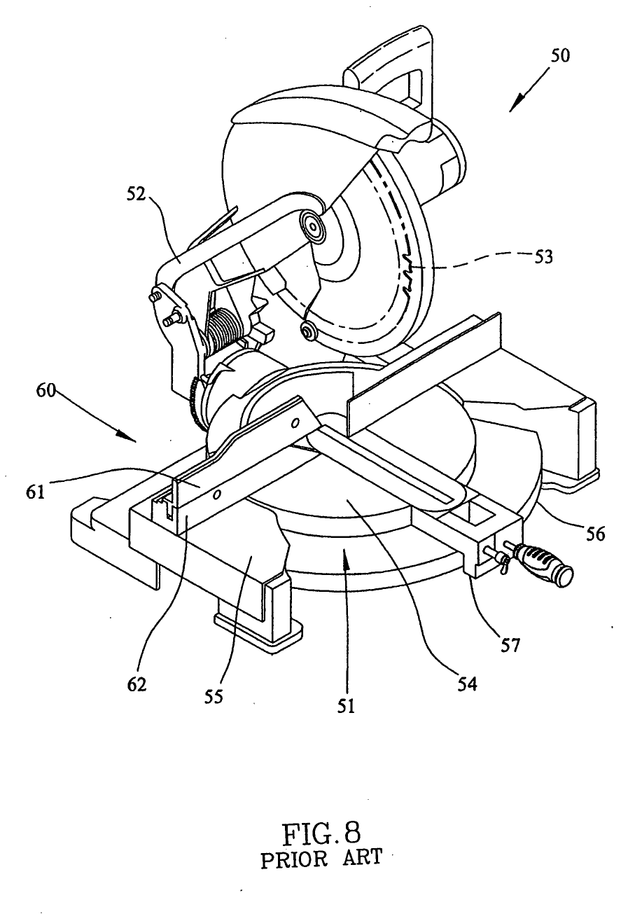

### DETAILED DESCRIPTION OF THE INVENTION

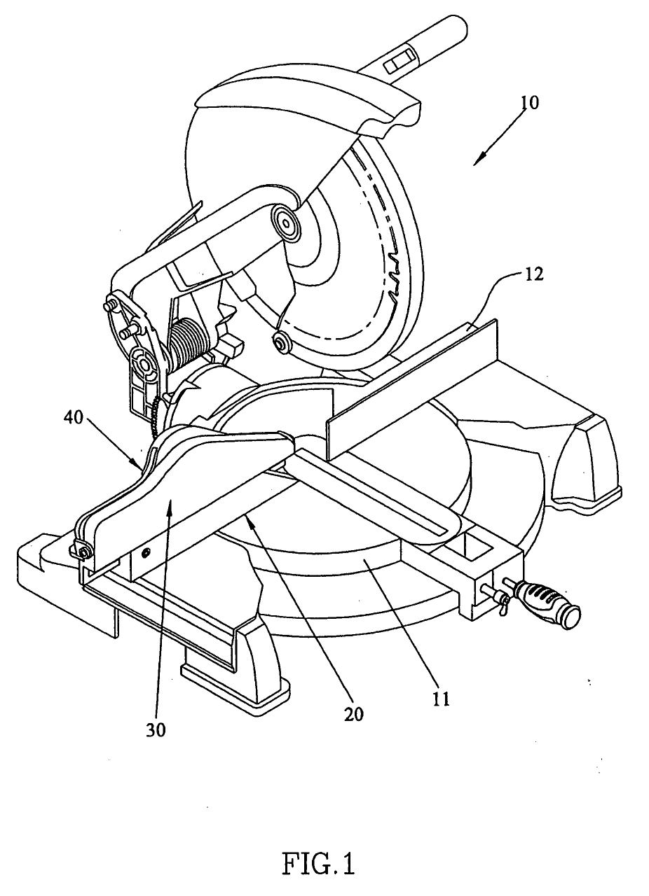

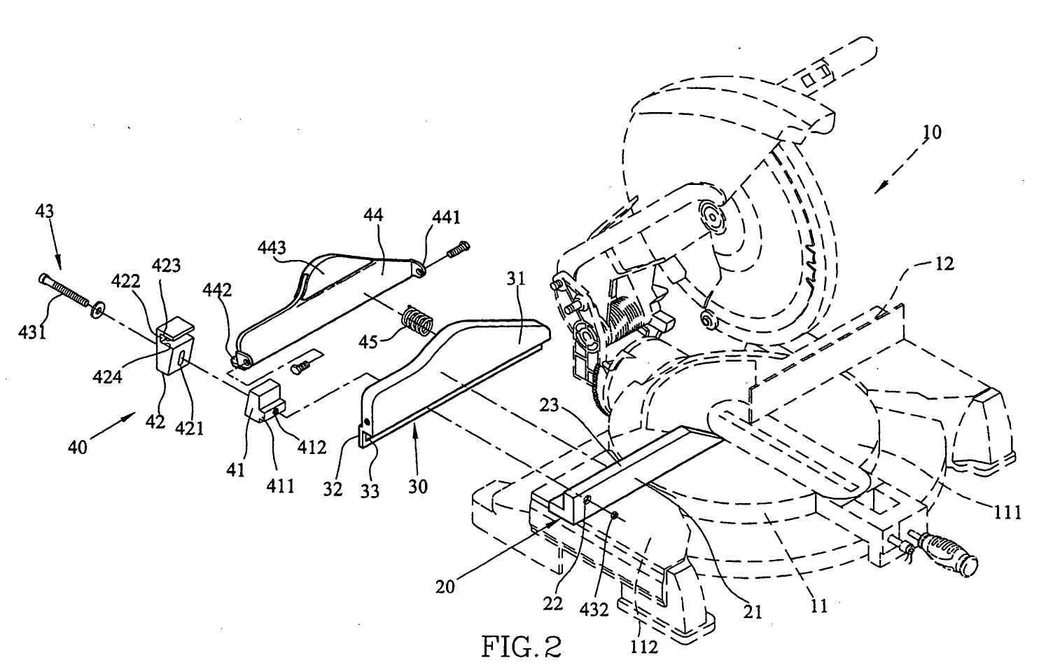

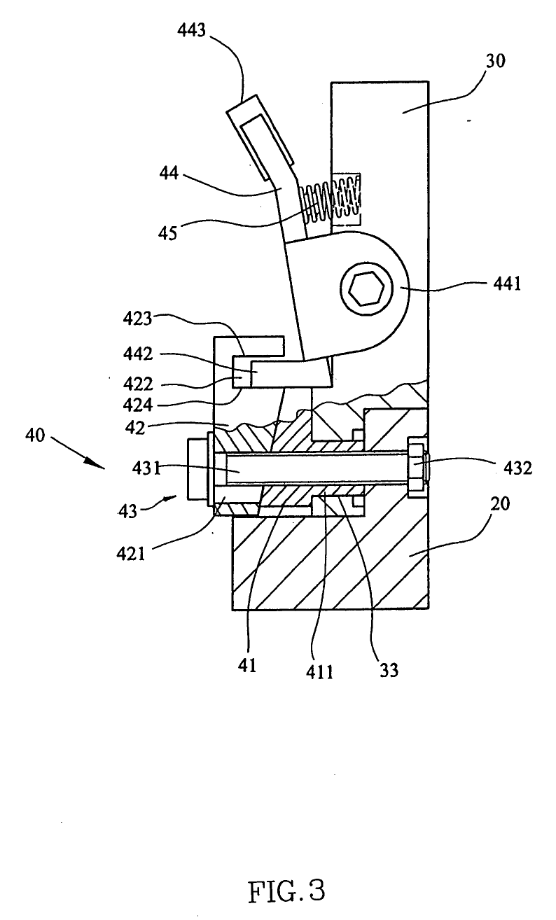

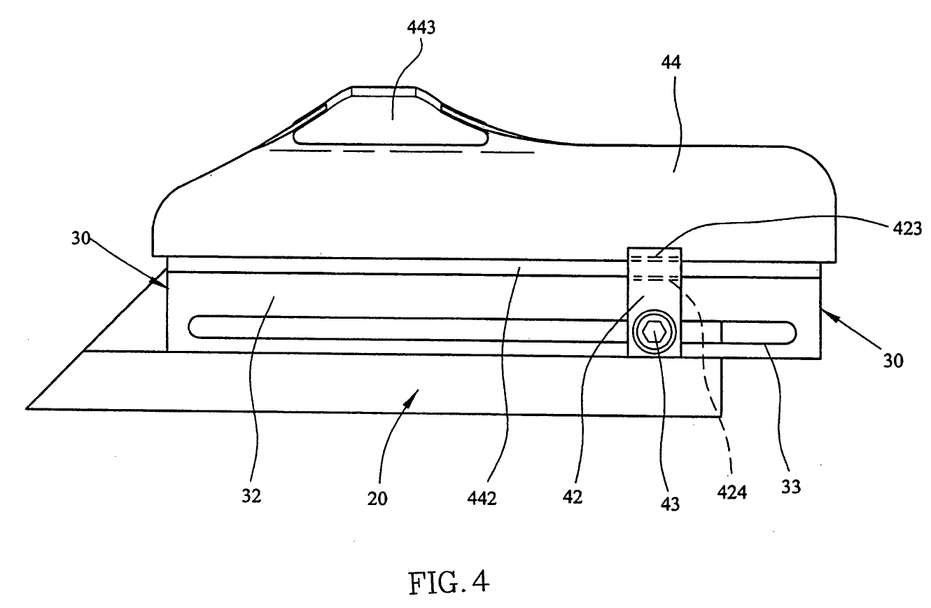

Referring to FIGS. 1-4, a fence assembly 12 in accordance with the present invention is shown installed in a cut-off machine 10. According to an embodiment, the cut-off machine 10 includes a worktable 11. The fence assembly 12 is provided on the top side of the worktable 11 for stopping a workpiece put on the worktable 11 to be cut in position by the cut-off machine 10.

The fence assembly 12 includes a fence base 20, a fence plate 30 mounted on the fence base 20, and a locking structure 40. The aforesaid worktable 11 may be made in a fixed form or rotatable form. The fence assembly 12 is applicable to either fixed form or rotatable form. According to this embodiment, the worktable 11 is a rotatable design including a fixed table 112 and a rotating table 111 rotatably supported on the fixed table 112. The fence base 20 is fixedly mounted on the fixed table 112 and extends over the top side of the rotating table 111, having an upright sidewall 21 perpendicular to the top side of the rotating table 111 and a through hole 22 drilled through the fence base 20 from the upright sidewall 21 near one end of the sidewall 21.

The fence plate 30 is provided above the top side 23 of the fence base 20, having a vertical top panel 31 arranged in parallel to and in flush with the upright sidewall 21 of the fence base 20, a vertical bottom panel 32 downwardly extending from the bottom side of the vertical top panel 31 in parallel to the upright sidewall 21, and a sliding slot 33 formed on the bottom panel 32 along the length direction of the bottom panel 32. The vertical top panel 31 is mounted above the upright sidewall 21 of the fence base 20 in flush with one side, namely, the outer side of the fence base 20. The vertical bottom panel 32 is closely attached to the other side, namely, the inner side of the fence base 20. The sliding slot 33 formed on the bottom panel 32 corresponds to the through hole 22 of the fence base 20.

The locking structure 40 includes a locating block 41, a stop block 42, a fastener 43, a press member 44 and an elastic member 45. The locating block 41 has a locating flange 411 extending from its one lateral side. The vertical width of the locating flange 411 fits the width of the sliding slot 33 of the fence plate 30 so that the locating flange 411 can be fitted into the sliding slot 33 of the fence plate 30 and kept in contact with the fence plate 30 stably. The other lateral side of the locating block 41 opposite to the side from which the locating flange 411 extends is a sloping side. The width between the two opposite lateral sides of the locating block 41 reduces gradually upwardly. The locating block 41 further has a through hole 412 drilled through the locating flange 411 and its two opposite lateral sides.

The stop block 42 has a sloping lateral side according with the slope of the sloping lateral side of the locating block 41 so that the stop block 42 and the locating block 41 can be matched together. The stop block 42 has a vertically long through hole 421 drilled through its two opposite lateral sides and a locating groove 422 formed on its top part above the long through hole 421. The locating groove 422 has a top wall 423 and a bottom wall 424. Further, an open side of the locating groove 422 is toward the locating block 41.

The fastener 43 according to this embodiment includes a bolt 431 and a nut 432. The bolt 431 is inserted in proper order through the long through hole 421 of the stop block 42, the through hole 412 of the locating block 41 and the through hole 22 of the fence base 20, and then screwed up with the nut 432. The through hole 412 of the locating block 41 and the through hole 22 of the fence base 20 have a diameter corresponding to the diameter of the cross section of the bolt 431 so that the locating block 41 and the fence plate 30 are prohibited from vertical displacement relative to the bolt 431. However, because the through hole 421 of the stop block 42 is a vertically extending long hole, the stop block 42 is allowed for vertical displacement relative to the bolt 431.

The press member 44 has two lugs 441 respectively perpendicularly extending from its two distal ends toward the fence plate 30 and pivotally coupled to the two distal ends of the fence plate 30. The elastic member 45 according to this embodiment is a spring member connected between the press member 44 and the vertical top panel 31 of the fence plate 30 above the elevation of the lugs 441. The press member 44 further has a protruding portion 442 extending from its bottom side and inserted into the locating groove 422 of the stop block 42.

When the user does not press the press member 44, the elastic member 45 pushes the press member 44 outwards from the fence plate 30. At this time, the protruding portion 442 of the press member 44 inserted into the locating groove 422 of the stop block 42 presses on the bottom wall 424 of the locating groove 422 to prohibit upward displacement of the stop block 42. When tightening the fastener 43, the fastener 43 provides a clamping area that provides a clamping force to the stop block 42 and the fence base 20 from two opposite sides thereof. The length of this clamping area is from the head of the bolt 431 to the fence base 20. At this time, the contact surface between the locating block 41 and the stop block 42 slopes in clockwise direction toward the clamping force. Because of the limitation of the press member 44, the stop block 42 is prohibited from upward displacement. Therefore, the stop block 42, the locating block 41, the fence plate 30 and the fence base 20 are firmly secured together, and the vertical bottom panel 32 of the fence plate 30 is firmly sandwiched between the locating block 41 and the fence base 20, prohibiting sliding movement of the fence plate 30 relative to the fence base 20 by means of sliding slot 33.

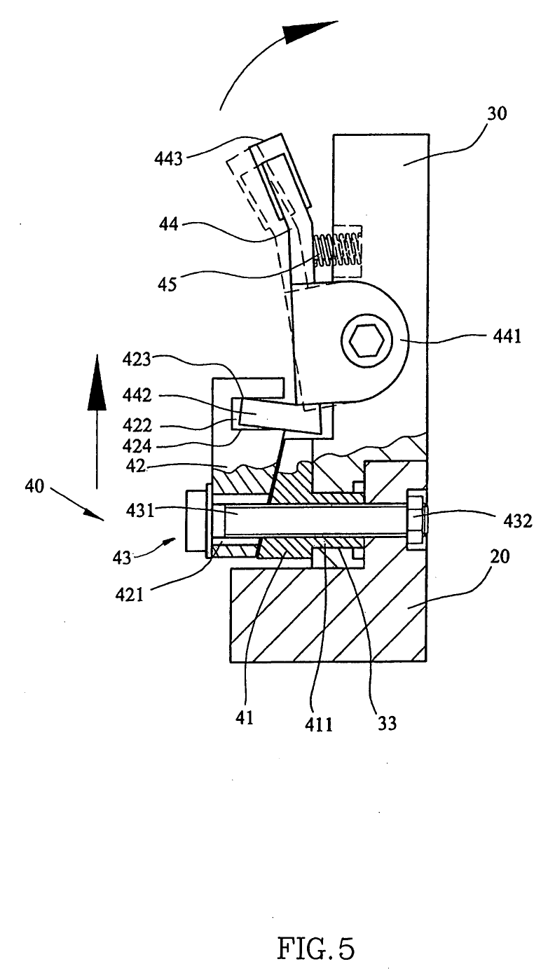

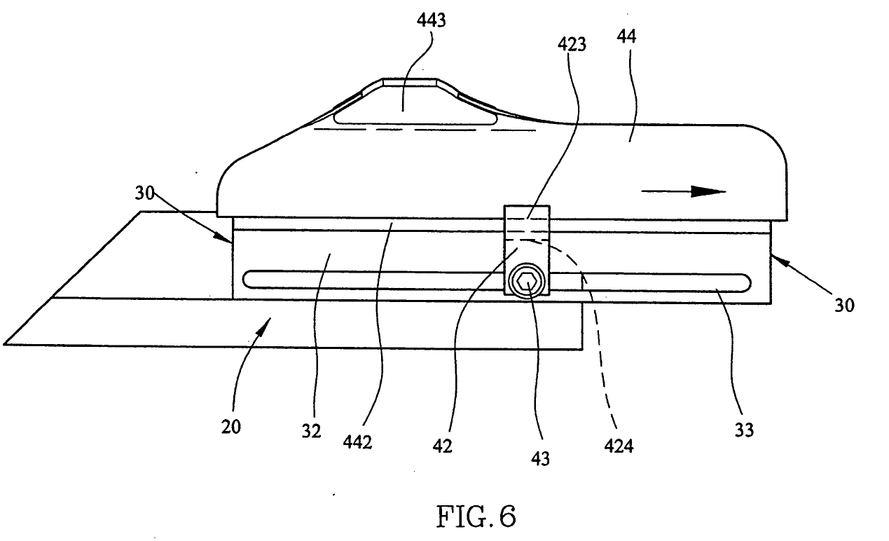

Referring to FIGS. 5 and 6, when wishing to move the fence plate 30 relative to the fence base 20 and to further adjust the length of the fence assembly 12, press the top portion 443 of the press member 44 to make the top portion 443 pivoted toward the fence plate 30 against the elastic member 45. At this time, the protruding portion 442 is moved toward the top wall 423 of the locating groove 422 to push the top wall 423 so as to lift the stop block 42. Because the length of the clamping area is constant, a gap appears between stop block 42 and the locating block 41 after the stop block 42 lifted to result in disappearance of the clamping force. Therefore the fence plate 30 can be 20 moved relative to and along the fence base 20.

Further, because the periphery of the sliding slot 33 is kept in contact with the locating flange 411 of the locating block 41 but not the bolt 431, the contact length between the periphery of the sliding slot 33 and the locating flange 411 of the locating block 41 is long enough to support stable sliding movement of the fence plate 30 25 relative to the fence base 20 guided by the sliding slot 33. Moreover, the top portion 443 of the press member 44 curves slightly outwards to increase its distance to the fence plate 30, facilitating operation.

As stated above, the contact surface between the locating block 41 and the stop block 42 slopes in clockwise direction toward the clamping force of the fastener 43. When the fastener 43 is tightened, and the press member 44 presses the stop block 42, the stop block 42, the locating block 41, the fence plate 30 and the fence base 20 are firmly secured together. As a result, the stop block 42 is stopped from moving upwardly, and the vertical bottom panel 32 of the fence plate 30 is firmly sandwiched between the locating block 41 and the fence base 20, prohibiting sliding movement of the fence plate 30 relative to the fence base 20. When wishing to adjust the length of the fence assembly 12, simply press the press member 44 to lift the stop block 42 to have the clamping force of the fastener 43 disappear, so as to allow sliding movement of the fence plate 30 relative to the fence base. After releasing the press member 44, the elastic member 45 immediately returns the-press member 44 to its former position to fasten the fence plate 30. This design is convenience in use. Further, the press member 44 has a curved top portion to facilitate operation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fence assembly installed in a cut-off machine and disposed on a worktable of the cut-off machine for stopping a workpiece on the worktable to be cut in position by the cut-off machine, the fence assembly comprising:
a fence base fixedly provided above the worktable of the cut-off machine;
a main fence device supported on the fence base; and
a locking structure for controlling if the main fence device is locked to the fence base, the locking structure comprising a fastener defining a separation with a constant length from the fence base, a first block, wherein the first block and a bottom part of the main fence device are crowded into the separation, the bottom part of the main fence device is disposed between the first block and the fence base, the contact surface between the first block and the bottom part of the main fence device slopes toward the direction of the separation, and the first block is movable substantially perpendicularly to the direction of the separation, and a press member selectively pressing the first block to prevent the movement of the first block.

2. The fence assembly as claimed in claim 1, wherein the main fence device comprises a fence plate movable along the fence base, and the bottom part of the main fence device comprises a bottom panel of the fence plate and a second block, wherein the bottom panel is disposed between the second block and the fence base, and the contact surface between the first block and the bottom part of the main fence device is the contact surface between first block and the second block.

3. The fence assembly as claimed in claim 2, wherein the fence base has an upright sidewall perpendicular to a top surface of the worktable on which the workpiece is supported.

4. The fence assembly as claimed in claim 3, wherein the fence plate has a top panel above and in flush with the upright sidewall of the fence base.

5. The fence assembly as claimed in claim 2, wherein the bottom panel of the fence plate has a sliding slot, and the second block has a locating flange extending from one side thereof and inserting through the sliding slot of the fence plate, the locating flange fitting the width of the sliding slot.

6. The fence assembly as claimed in claim 2, wherein the first block defining a vertically long through hole therein for the passing of the fastener.

7. The fence assembly as claimed in claim 6, wherein the fastener comprises a bolt inserted through the first block, the second block, the bottom panel of the fence plate and the fence base, the bolt having a head stopped at one side of one of the first block and the fence base, and a nut threaded onto the bolt and stopped at one side of the other one of the first block and the fence base.

8. The fence assembly as claimed in claim 2, wherein the press member is pivoted to the fence plate, and the locking structure further has an elastic member disposed between the press member and the fence plate above the pivotal joint of the press member to force the press member apart from the fence plate against the first block.

9. The fence assembly as claimed in claim 8, wherein the first block provides a locating groove in a top portion thereof, and the press member has a protruding portion inserted into the locating groove.

10. The fence assembly as claimed in claim 9, wherein the protruding portion extends from a bottom side of the press member.

11. The fence assembly as claimed in claim 9, wherein the locating groove of the first block has a top wall and a bottom wall, the protruding portion of the press member pushes the top wall of the locating groove to lift the first block relative to the fastener when the press member is pivoted by an external force to compress the elastic member, and the elastic member pushes the press member to cause the protruding portion to press the bottom wall when the external force disappear.

12. The fence assembly as claimed in claim 8, wherein the press member has a top portion curved outwards.

13. The fence assembly as claimed in claim 2, wherein the contact surface between the first block and the second block slopes in clockwise direction toward the direction of the separation.
